(19) United States
(12) Patent Application Publication
(10) Pub. No.: US 2024/0310218 A1
(43) Pub. Date: Sep. 19, 2024

(54) TEMPERATURE SENSOR ASSEMBLY AND SENSOR CARRIER WITH A TEMPERATURE SENSOR ASSEMBLY

(71) Applicant: WIKA Alexander Wiegand SE & Co. KG, Klingenberg (DE)

(72) Inventors: Jürgen Bräutigam, Elsenfeld (DE); Andreas Cohrs, Unna (DE)

(21) Appl. No.: 18/602,542

(22) Filed: Mar. 12, 2024

(30) Foreign Application Priority Data
Mar. 13, 2023 (DE) 10 2023 106 232.8

(51) Int. Cl. G01K 1/14; G01K 1/12; G01K 1/143

(52) U.S. Cl. CPC G01K 1/146; G01K 1/12; G01K 1/143

(57) ABSTRACT

The present disclosure relates to a temperature sensor assembly including a mounting device with a front side and a rear side opposite the front side, and a temperature sensor with a temperature-sensitive measuring tip. The temperature sensor is inserted into the mounting device through an opening in the rear side in such a way that the measuring tip points in a direction whose angle to a surface normal of the front side is less than 90°, the temperature sensor being held within the mounting device by an insulation device held by the mounting device.

### TECHNICAL FIELD

The present disclosure relates to a temperature sensor assembly. The present disclosure further relates to a sensor carrier with such a temperature sensor assembly.

A temperature sensor is known from U.S. Pat. No. 5,743,646 A. The temperature sensor comprises a hollow tube having a first end and a second end, the second end being closed and sealing a cavity within the tube from an environment outside the tube. The first end comprises an outer cylindrical surface. The temperature sensor comprises a temperature-responsive sensor element located within the tube near the second end and a glass cylinder having an inner cylindrical surface that is in sealing engagement with the outer cylindrical surface of the first end of the tube. Further, the temperature sensor comprises a sensor housing having an inner cylindrical cavity bounded by an inner cylindrical wall, wherein an outer cylindrical surface of the glass cylinder is sealingly engaged with the inner cylindrical wall.

Furthermore, a stirring device with a temperature measuring device is known from JP 2010 185 766 A. The stirring device is designed as a filter/drying device which comprises a container with a cylindrical side and stirring blades which are rotatable about a central axis of the container. The temperature measuring device is arranged on the side of the container to measure the temperature of a material processed inside the container. The temperature measuring device comprises a sheathed thermocouple in which a thermocouple is housed within a sheath. Furthermore, the temperature measuring device comprises a cylindrical protection tube in which the sheath thermocouple is housed. A temperature sensitive portion having a predetermined length at the tip of the sheath thermocouple is fixed in close contact with an inner surface of an end plate of the protection tube.

US 2018/0 003 566 A1 describes a temperature measuring rod comprising a sheath, a longitudinal chamber contained in the sheath between an interface with an external environment and an extension piece for measurement belonging to the sheath, and a thermocouple received in the chamber. The thermocouple comprises a flexible cable forming an outer sheath of the thermocouple. The chamber is bounded by a cable sheath and the interface includes a conical opening for insertion of the cable. The opening leads to the chamber and becomes thinner in the direction of the chamber. Furthermore, the thermocouple comprises a locking element which can be locked at the interface.

### SUMMARY OF THE PRESENT DISCLOSURE

According to a first aspect of the present disclosure, a temperature sensor assembly comprises a mounting device, a temperature sensor and an insulation device.

The mounting device comprises a front side and a rear side facing away from the front side, in particular opposite to the front side. When the temperature device is used to measure the temperature of a medium, installed in or as part of a device, the front side faces the medium, in particular comes into contact with it, while the rear side faces away from the medium.

The temperature sensor comprises a temperature-sensitive measuring tip. In exemplary embodiments, the measuring tip can in particular comprise a sensor element that is arranged directly at or near one end of the measuring tip. For example, a thermistor or a so-called thermocouple can be used as the sensor element. A body of the temperature sensor, which is designed as a mineral-insulated sheathed cable, for example, extends to the rear side of the measuring tip. In exemplary embodiments, the sheathed cable extends to the measuring tip, encloses it and is closed at the measuring tip. At the end of the body of the temperature sensor facing away from the measuring tip, it comprises electrical contacts in particular in order to connect the sensor element to an electronic evaluation unit.

The mounting device comprises an opening on a side or surface facing away from the front side, in particular on the rear side. The temperature sensor is inserted into this opening in such a way that the measuring tip penetrates the mounting device at least in sections and points in a direction whose angle to a surface normal of the front side is less than 90°.

This ensures that the measuring tip points at least essentially in the same direction as the surface normal of the front side. As a result, an imaginary extension of the temperature sensor penetrates beyond its measuring tip into the volume adjacent to the front side. When using the temperature device to measure the temperature of a medium, this means that the imaginary extension extends into the medium. This means that the temperature sensor does not run parallel to the front side in the area of its measuring tip and the measuring tip points in a direction that forms an angle of less than 90° with the surface normal of the front side. Such an arrangement allows a particularly compact design to be achieved and the temperature sensor does not have to be strongly curved—especially in the vicinity of the measuring tip—so that its structure remains as intact as possible. In exemplary embodiments, it can be provided that the angle between the direction in which the measuring tip points and the surface normal of the front side is less than 70°, preferably less than 50°. As a result, the aforementioned advantages can be achieved in a variety of installation situations and geometries. Furthermore, in exemplary embodiments in which the front side comprises a curved surface at least in sections, the surface normal (which forms an angle of less than 90° with the direction in which the measuring tip points) can be determined at the point on the front side that comes closest to the measuring tip. Alternatively, the surface normal can also be determined at a center point of the front side.

The insulation device is designed to hold the temperature sensor in a defined position within the mounting device. This means that the temperature sensor is fixed within the mounting device by the insulation device and any displacement and/or rotation of the temperature sensor relative to the mounting device is directly or indirectly blocked by the insulation device. In this context, direct blocking means that displacement and/or rotation of the temperature sensor is prevented by direct contact, clamping, wedging or other material-locked, form-fit or force-fit interaction between the temperature sensor and the insulation device. Indirect blocking, on the other hand, means that other parts are involved in preventing the displacement or rotation, which are not directly part of one of the two elements.

For this purpose, the insulation device itself is held or fastened within the mounting device, whereby this holding or fastening of the insulation device within the mounting device is to be understood in the same way as that described in the previous section with regard to the holding of the temperature sensor by the insulation device.

The insulation device is made of a material which comprises a low thermal conductivity, or it comprises at least parts made of such a material. In exemplary embodiments explained in more detail below, in which the insulation device comprises one or more insulating bodies, for example, these insulating bodies can be made of Teflon or a comparable material.

The present temperature sensor assembly thus comprises the advantage that, although the temperature sensor can be fixed in a defined position, it is thermally decoupled from the mounting device and thus also from a structure or device in which the temperature sensor assembly may be installed or integrated in an application, or at least a thermal coupling to the mounting device is significantly reduced. As a result, an increased measurement accuracy and a reduced response time of the temperature sensor in relation to a temperature of a medium to be measured can be achieved.

The temperature sensor assembly comprises only a few parts, can therefore be manufactured cost-effectively and can also be assembled or installed easily and in just a few steps.

In an exemplary embodiment of the temperature sensor assembly, the insulation device comprises a front face which is at least substantially flush with a surface section of the front side of the mounting device. As a result, edges can be avoided and the effect of force on the insulation device, in particular due to media flowing past (if the temperature sensor assembly is arranged, installed or integrated in an application within a wall section adjacent to a medium), can be reduced so that the temperature sensor assembly can be operated reliably over a longer period of time and is not damaged.

In an exemplary embodiment of the temperature sensor assembly, the mounting device is sleeve-shaped and encloses the insulation device at least in sections. In this context, “in sections” means that the insulation device can also protrude beyond the mounting device and the elements only partially overlap or enclose each other. In connection with the above-mentioned embodiment, in which the front face of the insulation device is flush with the front side of the mounting device, this naturally means that the insulation device may only protrude from the mounting device through a side of the mounting device facing away from the front side, for example through the opening through which the temperature sensor is also inserted into the mounting device.

In a further exemplary embodiment of the temperature sensor assembly, the mounting device comprises a through hole. In particular, this starts at the opening in the rear side and continues through the mounting device to the front side. In exemplary embodiments, the through hole comprises several sections with different diameters.

The insulation device comprises at least one insulation body comprising an at least essentially cylindrical outer surface, which is enclosed at least in sections by the mounting device.

In exemplary embodiments of this embodiment, the mounting device comprises fastening means at least in sections on an inner wall of the through hole and the insulation device or an insulation body comprised by the insulation device comprises fastening means on an outer wall. These fastening means are designed to enter into an operative connection with one another so that the insulation device can be held or fastened within the mounting device.

The fastening means comprise, for example, an internal thread of the mounting device and an outer thread of the insulation device or an insulation body. Other connections can also be used, for example defined geometries, so that the insulation device can be pressed into the mounting device.

The aforementioned embodiment as well as its further development and exemplary embodiments comprise the advantage of being particularly simple and inexpensive to manufacture, requiring a small number of components and yet enabling a mechanically stable structure of the temperature sensor assembly.

In a further exemplary embodiment of the temperature sensor assembly, the measuring tip comprises an end face which is at least substantially flush with a surface section of the front face of the insulation device and/or a surface section of the front side of the mounting device. As a result, protruding edges can be avoided so that the elements—in particular the measuring tip—can be protected from mechanical loads or the effects of force. In an exemplary embodiment, the front face, front side and end face are simultaneously flat and arranged flush with each other, which can further increase the aforementioned advantages.

In this embodiment, the end face is not covered, at least in sections, by either the insulation device or the mounting device. Thus, the end face is directly accessible to a medium, at least in sections, if the temperature sensor assembly is installed or integrated into a wall section of a structure or device which encloses the medium or at least adjoins it. This enables effective thermal coupling between the measuring tip and the medium, so that the measuring accuracy and response time of the temperature sensor can be improved.

In a further exemplary embodiment of the temperature sensor assembly, the temperature sensor comprises a contact body. The contact body is formed, for example, by an at least essentially cylindrical widening on the measuring tip. In particular, the contact body serves the purpose of increasing an area over which the measuring tip can come into thermal contact with a medium when the temperature sensor assembly is installed in a wall section of a structure or device that is adjacent to the medium. As a result, thermal resistance between the medium and the measuring tip or the sensor element of the measuring tip can be reduced, so that measurement accuracy can be increased and/or a response time can be reduced in an advantageous manner. For this purpose, the contact body comprises a contact surface on the front side, which is not covered by either the insulation device or the mounting device, at least in part.

In an exemplary embodiment, the contact surface comprises a surface normal which forms an angle of less than 90° with the surface normal of the front side of the mounting device. At the same time or alternatively, the contact surface can be flush with the front side of the mounting device and/or the front face of the insulation device. In addition, it may be provided that the contact surface, the front side and the front face lie on a common, flat or curved surface. Such designs provide the smallest possible lateral contact surface for flowing media and the temperature sensor assembly is easier to clean from residues of a process medium.

In an exemplary embodiment, the contact body is formed on the measuring tip in that the contact body is formed from a block or cylinder of solid material and comprises a through hole into which the measuring tip is inserted from a side facing away from the contact surface and is advanced until it is flush with the contact surface. Alternatively, a blind hole can also be provided in the contact body, which ends just below the contact surface, whereby the measuring tip is inserted and advanced into the blind hole in such a way that the end face of the measuring tip abuts against the end of the blind hole. In both variants, the measuring tip can be connected to the contact body by a soldered connection, for example, so that high mechanical stability and good thermal coupling are possible.

In exemplary embodiments, the contact body is made of a material with a high coefficient of thermal conductivity. For example, the contact body is at least partially made of silver, copper, gold or aluminium or of an alloy comprising at least one of the elements mentioned. As a result, the purpose of the contact body described in the previous section can be achieved particularly effectively.

In an exemplary further development of the aforementioned embodiment of the temperature sensor assembly, the contact body is held or fixed in a defined position within the mounting device by the insulation device. This means that the temperature sensor as a whole is held or fastened via a mechanical contact between the contact body and the insulation device. In particular, it can be provided that the temperature sensor or at least the measuring tip otherwise has no mechanical contact with the insulation device and/or the mounting device. This can advantageously enable thermal decoupling or at least further reduce thermal conduction between the mounting device and the temperature sensor.

In a further exemplary further development of the aforementioned embodiment of the temperature sensor assembly, the through hole or blind hole runs at an angle to a surface normal of the contact surface and/or at an angle to the surface normal of the front side. This means that the temperature sensor is inserted at an angle through the opening in the rear side of the mounting device. As a result, the temperature sensor or the body of the temperature sensor does not have to be curved as much in order to be able to follow a path from the rear side of the mounting device that is orthogonal to a surface normal of the contact surface. This is particularly advantageous if the temperature sensor assembly is arranged on a sensor carrier in which less installation space is available on an inner or rear side facing away from the medium whose temperature is to be measured. For example, the through hole or blind hole and the surface normal can intersect at an angle of 15° to 50°, whereby an optimum compromise can be achieved between reducing the necessary curvature of the temperature sensor and a narrow design of the temperature sensor assembly.

In a further exemplary further development of the aforementioned embodiment, at least one recess, for example four recesses, is provided in the rear side of the mounting device, which adjoins the opening in the rear side through which the temperature sensor is inserted into the mounting device. This makes it possible to advantageously achieve that the temperature sensor can be guided to the angled through hole or blind hole explained in the previous paragraph without coming into direct contact with the mounting device. In this way, thermal decoupling between the temperature sensor and the mounting device is improved or not undermined and, at the same time, the temperature sensor assembly can be adapted to narrow installation conditions.

In another exemplary further development of the aforementioned embodiment of the temperature sensor assembly, the contact body is formed from a block-shaped or cylindrical solid body and comprises a through hole. An opening of this bore is located in the contact surface and is closed by a front membrane attached to or on the contact surface. The measuring tip is inserted into the through hole and pushed forward in such a way that it lies directly against the inside of the front membrane facing the bore channel. This allows the measuring tip to be protected from chemical or mechanical damage by the front membrane. Since the front membrane is thin-walled, thermal coupling of the measuring tip to a medium, which in an application is in contact with the front side of the front membrane facing away from the bore, is not impaired.

In an exemplary embodiment of this further development, the sensor element of the measuring tip is exposed and comes into direct contact with the rear side of the front membrane. This can be achieved, for example, by removing an end section of a sheathed cable of the temperature sensor in the area of the measuring tip. In this way, an even better thermal coupling of the sensor element to the front membrane can be achieved in an advantageous manner.

In a further exemplary embodiment of the temperature sensor assembly, the temperature sensor comprises a protrusion at a point along its sensor body or in the area of the measuring tip. This protrusion protrudes from a lateral surface of the temperature sensor or the measuring tip and is fixedly attached to the temperature sensor. In an exemplary embodiment, the protrusion is formed by an annular disk which is connected to the body of the temperature sensor or to the measuring tip, for example by a soldered connection.

In this embodiment, the insulation device comprises, for example, at least a first and a second insulation body.

The first insulation body is, for example, cylindrical in shape and inserted into a through hole or a through hole section of the mounting device. The first insulation body is either rigidly connected to the mounting device—for example by a press or adhesive connection—or rests against at least one stop of the mounting device, so that displacement of the first insulation body along an axis of the through hole of the mounting device is blocked at least in one direction by the stop. In addition, the first insulation body comprises a clamping surface, which is formed on a side of the insulation body facing away from the stop of the mounting device.

The protrusion rests against this clamping surface with a first protrusion side, so that displacement of the temperature sensor in the direction of the stop is prevented by the stop—mediated via the first insulation body.

The second insulation body comprises a second clamping surface and an outer thread. The second insulation body is screwed into an internal thread of the holding device or the first insulation body with the outer thread. The second clamping surface on the second insulation body, the thread and the stop of the holding device are arranged relative to one another in such a way that, when the second insulation body is screwed in, the second clamping surface points in the direction of the stop, the first insulation body and the protrusion and moves towards this arrangement until the second clamping surface comes into contact with a second protrusion side of the protrusion. The protrusion is thus clamped from two opposite sides in particular and axial displacement of the temperature sensor relative to the mounting device is blocked in both directions. As an alternative to the outer thread and the threaded connection with the mounting device or the first insulation body, the second insulation body can also be rigidly connected to the mounting device or the first insulation body by means of an adhesive connection or an interference fit. The respective rigid connection must then be made in such a way that, in the fixed position, the protrusion of the temperature sensor is clamped between the clamping surfaces of the insulation bodies, as already described above.

The insulation bodies comprise, for example, central through holes whose diameter is matched to an outer diameter of the temperature sensor with a fit, so that the temperature sensor can be arranged and held in a defined manner within these holes. Furthermore, since at least the second insulation body cannot be displaced radially relative to the mounting device or the first insulation body due to the threaded connection, the adhesive connection or the press fit with the mounting device or the first insulation body, the temperature sensor is also prevented from radial displacement.

For the purposes of this embodiment, the terms ‘first clamping surface’ and ‘second clamping surface’ are not to be understood as meaning that further clamping surfaces must be present. In particular, this does not imply that the first insulation body comprises other clamping surfaces in addition to the first clamping surface. Similarly, the second insulation body does not have to comprise any other clamping surfaces apart from the second clamping surface. The designations ‘first’ and ‘second’ are merely used here to clearly address and assign the respective first or second insulation body.

The embodiment described above provides a temperature sensor assembly which comprises a particularly small number of components, can be assembled in a few simple steps and yet achieves the advantageous features of good thermal decoupling between the temperature sensor and the mounting device as well as reliable fastening of the temperature sensor in a defined position relative to the mounting device.

Advantageously, in exemplary embodiments, all of the aforementioned embodiments, configurations and examples can be combined with one another as desired, insofar as they are not mutually exclusive.

According to a second aspect of the present disclosure, a sensor carrier comprises a wall section with at least one measuring point.

By wall section is meant a section or surface area of a wall which is part of a superordinate structure. In exemplary embodiments, the wall section may, for example, be part of a wall of a container, in particular a pressure vessel, within which a medium is stored and/or processed. In a further exemplary embodiment, the wall section may be part of a pipeline wall, wherein a medium is conducted inside the pipeline. However, in a further embodiment, the wall section may also be part of a structure which serves the specific purpose of holding the sensor carrier and, in particular, of bringing the sensor carrier into a defined position. Such a structure can be in the form of a protection tube, for example. Protection tubes are generally known from the prior art in many variants. Any part of the protection tube can be considered as a wall section. For example, this can mean a tip, i.e. an end face of a tube body of the protection tube; alternatively, however, it can also mean a lateral surface of the protection tube.

The sensor carrier thereby comprises at least one temperature sensor assembly according to one of the embodiments or examples according to the previously explained first aspect of the present disclosure. Such a temperature sensor assembly is arranged or formed at the at least one measuring point or integrated into the measuring point.

In this context, integration means that the mounting device is either irreversibly connected to the wall section—for example by a welded connection—or the geometry of the mounting device, for example with holes, threaded section or the like, as explained with reference to the first aspect of the present disclosure, is formed directly in the wall. The latter variant is particularly advantageous if the wall section of the sensor carrier is easily accessible or if the sensor carrier as a whole or a superordinate structure, in the wall of which the wall section is located, comprises compact dimensions so that the structure or the sensor body as a whole can be precisely machined by corresponding machines such as milling machines or lathes or drilling machines. This means that the number of components can be further reduced so that the mounting device is no longer an independent individual part, but is instead formed directly in the wall section. This also reduces the number of connection joints, which means that leaks between the mounting device and the wall section can be avoided.

In other possible embodiments, however, if the superordinate structure is very large or massive, such as large containers or pipelines with a wide diameter, it is advantageous if the at least one measuring point can only be prepared to accommodate a temperature sensor assembly by particularly simple means. For example, the measuring point can comprise a through hole through the wall section, which is provided with an internal thread. The mounting device of the temperature sensor assembly then comprises a matching outer thread and can be screwed into the wall section at the measuring point in a simple manner. Alternatively, the measuring point can simply comprise a through hole into which the mounting device is inserted and welded. To make it easier to position the mounting device in the through hole, a stop can be provided in the through hole against which the mounting device rests and thus cannot slip through the through hole.

In all variants and examples, the wall section is adjacent to a medium whose temperature is to be detected by the temperature sensor assembly. Accordingly, the front side of the mounting device, the front face of the insulation device and/or the end face of the measuring tip and/or the contact surface of the contact body, if present, are aligned in such a way that they face the medium and can come into contact with it. A body of the temperature sensor adjoining the measuring tip on the rear side is separated from the medium by the insulation device, mounting device and wall section and is thus protected in particular from mechanical or chemical interference by the medium.

In an exemplary embodiment of the sensor carrier, this comprises a temperature sensor assembly which—as explained in a previous section—comprises a temperature sensor with a protrusion, a mounting device with a stop and an internally threaded section, a first insulation body with a first clamping surface and a second insulation body with a second clamping surface.

Such a temperature sensor assembly can be constructed in two orientations:

If a side of the wall section of the sensor carrier, which is conveniently referred to below as the outer surface or outer side and which faces the medium, is more accessible than an inner surface or inner side, the temperature sensor assembly is constructed, for example, in such a way that the stop is provided on a side of the mounting device which does not face the medium. The first insulation body and the temperature sensor with its rear side body can then be pushed into the mounting device from the outer side until the first insulation body rests against the stop and the protrusion rests against the first clamping surface of the first insulation body. The second insulation body is then pushed onto the measuring tip and screwed into the internal thread of the mounting device from the outer side (or glued or pressed into the mounting device) until the second clamping surface of the second insulation body meets the second protrusion side and the protrusion is firmly clamped between the insulation bodies. If the second insulation body then protrudes further beyond the end face or contact surface of the temperature sensor, it can still be ground or cut off to create a flush surface.

If, on the other hand, a side of the wall section of the sensor carrier that faces away from the medium, conveniently referred to below as the inner surface or inner side, is more accessible than the outer surface or outer side, the temperature sensor assembly can be installed in an inverted form, for example: The stop of the mounting device is then arranged close to the front side or on the front side; the first insulation body is then inserted into the mounting device from the inside, followed by the temperature sensor and the second insulation body.

In a further exemplary embodiment, the sensor carrier comprises at least one further temperature sensor assembly according to one of the embodiments or examples according to the first aspect of the present disclosure explained in the foregoing. This allows the temperature of the medium to be measured at different points in an advantageous manner. In particular, the plurality of temperature sensor assemblies is arranged along a path and at a defined distance from one another. If this path comprises points with different heights in relation to a container in which the medium is stored or processed, not only the temperature of the medium at different points, but also a spatial or vertical temperature profile can be created. In particular, in this embodiment it may also be possible to determine a fill level of the medium based on the temperature distribution.

In an exemplary further development of the aforementioned embodiment, the sensor carrier is formed in a wall section of an industrial stirring bar or an industrial agitator, which is intended for stirring a medium that is stored or processed in a container. At least two measuring points are arranged along the path at different heights on the stirring bar or agitator. The advantages explained in the previous sections—in particular the measurement of a spatial temperature profile or a fill level—can also be used effectively in this embodiment.

### DESCRIPTION OF THE DRAWINGS

In the following, exemplary embodiments of the present disclosure and its exemplary further developments are explained in more detail with reference to figures.

They show:

FIG. 1 schematically shows a sensor carrier in cross-section,

FIG. 2 schematically shows an exemplary embodiment of a sensor carrier in cross-section,

FIG. 3 schematically shows an exemplary embodiment of the temperature sensor assembly from FIG. 2 in cross-section,

FIG. 4 schematically shows a cross-section of another exemplary embodiment of the temperature sensor assembly,

FIG. 5 schematically shows a cross-section of another exemplary embodiment of the temperature sensor assembly,

FIG. 6 schematically shows an exemplary embodiment of a temperature sensor in cross-section,

FIG. 7 schematically shows another exemplary embodiment of the temperature sensor in cross-section,

FIG. 8 schematically shows another exemplary embodiment of the temperature sensor assembly in cross-section,

FIG. 9A schematically shows another exemplary embodiment of the temperature sensor assembly in cross-section,

FIG. 9B shows a schematic rear view of the embodiment shown in FIG. 9A,

FIG. 10A schematically shows another exemplary embodiment of a sensor carrier in cross-section,

FIG. 10B schematically shows another exemplary embodiment of a sensor carrier in cross-section,

FIG. 10C schematically shows another exemplary embodiment of a sensor carrier in cross-section,

FIG. 10D schematic of a further exemplary embodiment of a sensor carrier in cross-section,

FIG. 11A schematically shows another exemplary embodiment of a sensor carrier in a side view and

FIG. 11B schematically shows another exemplary embodiment of a sensor carrier in cross-section.

Corresponding parts are provided with the same reference numbers in all figures.

### DETAILED DESCRIPTION

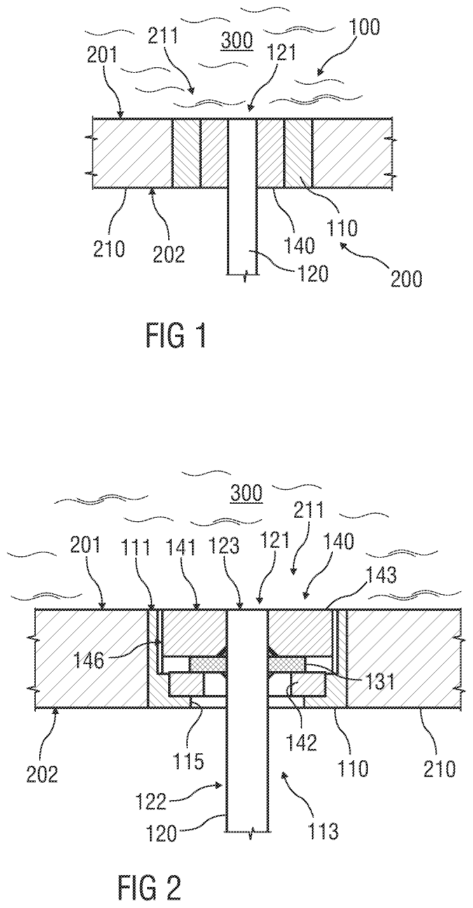

FIG. 1 schematically shows a sensor carrier 200 with a temperature sensor assembly 100 in cross-section. The sensor carrier 200 comprises a wall section 210, which is, for example, part of a wall of a container, a pipeline or a protection tube 230. An outer side 201 of the wall section 210 is adjacent to a medium 300, the temperature of which is to be measured. The temperature sensor assembly 100 comprises a mounting device 110, a temperature sensor 120 and an insulation device 140. As shown, the mounting device 110 is connected to the wall 210 at the location of a measuring point 211; for example, the mounting device 110 may comprise an outer thread with which it is screwed into an internal thread in a through hole through the wall section 210. The mounting device 110 in turn holds the insulation device 140, i.e. the insulation device 140 is fixed within the mounting device 110. The insulation device 140 in turn holds the temperature sensor 120 or at least its temperature-sensitive measuring tip 121. All the aforementioned elements comprising a side surface facing the medium 300 are flush with the outer side 201 in order to provide as small a lateral contact surface as possible. The sensor carrier 200 and the temperature sensor assembly 100 thus comprise only a few and simply designed components; however, the temperature sensor 120 can be fixed in a defined position within the mounting device 110 in a few simple steps and is thermally largely decoupled from the thermal mass of the surrounding wall section 210. At the same time, the measuring tip 121 comes into direct contact with the medium 300 to which the outer side 201 is adjacent in the application. As a result, a measurement accuracy of the temperature sensor 120 with respect to the temperature of the medium 300 can be increased and a response time can be reduced.

FIG. 2 schematically shows an exemplary embodiment of a sensor carrier 200 with a temperature sensor assembly 100 in cross-section. The mounting device 110 comprises a through hole 113 with several steps. On a side of the through hole 113 facing away from a front side 111 of the mounting device 110, a stop 115 is formed by a first step. The insulation device 140 comprises a front face 141 and comprises a first insulation body 142, which is inserted into the through hole 113 from the outer side 201, wherein its outer circumference is adapted to an inner diameter of a section of the through hole 113, which adjoins the stop 115. The first insulation body 142, which is annular in shape, rests against this stop 115 and thus cannot be moved in the direction of the inner side 202. The temperature sensor 120 is inserted into the mounting device 110 from the outer side 201 with its body 122 adjoining the measuring tip 121 on the rear side, so that the body 122 of the temperature sensor 120 passes through the first insulation body 142. The temperature sensor 120 comprises a protrusion 131, which is shown here as an annular disk, which is soldered or welded to an outer surface of the measuring tip 121. A second insulation body 143 of the insulation device 140 is then screwed into the mounting device 110 from the outer side 201 by means of a threaded connection 146, so that the protrusion 131 of the temperature sensor 120 is clamped between the insulation bodies 142, 143. Furthermore, the second insulation body 143, which is also annular in shape, comprises an inner diameter which is matched to the outer diameter of the measuring tip 121 with a defined fit. Thus, the measuring tip 121 is fixed in a defined position relative to the mounting device 110 and cannot be displaced either axially or radially.

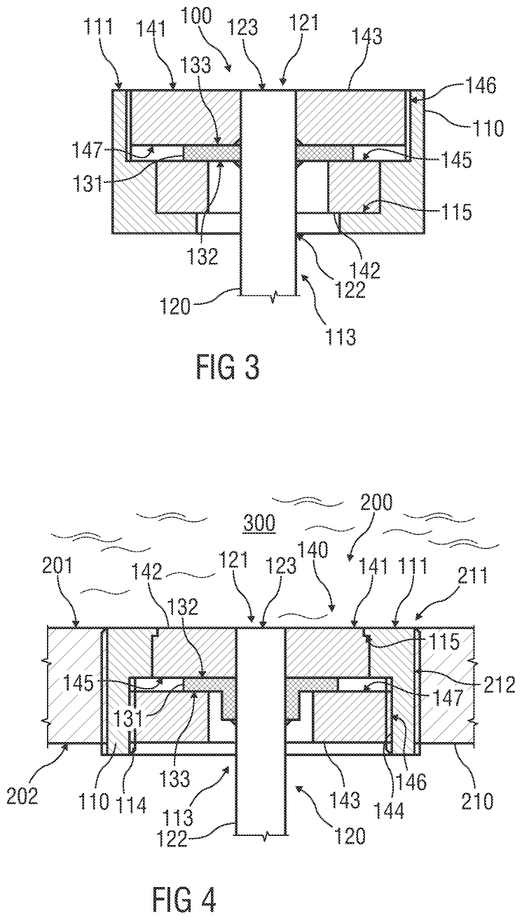

FIG. 3 shows an exemplary embodiment of the temperature sensor assembly 100, as already shown in FIG. 2, slightly enlarged in cross-section. It can be seen here how a first protrusion side 132 bears against a first clamping surface 145 on the first insulation body 142, while a second protrusion side 133 bears against a second clamping surface 147 on the second insulation body 143.

FIG. 4 schematically shows another exemplary embodiment of the sensor carrier 200 in cross-section. This structure is similar to that shown in FIG. 2, but this device is constructed in reverse with regard to the sequence of some components: The stop 115 is now positioned on the side facing the medium 300 near the front 111 of the mounting device 110. Thus, in this example, the insulation bodies 142, 143 and the temperature sensor 120 are inserted into the mounting device 110 from the inner side 202 facing away from the medium 300 and fastened. For example, the mounting device 110 is connected to the wall section 210 via a threaded connection 212 at the measuring point 211. The second insulation body 143 comprises an outer thread 144, with which it is screwed into an internal thread 114 of the mounting device 110.

FIG. 5 shows a schematic cross-sectional view of another exemplary embodiment of the temperature sensor assembly 100. In contrast to the embodiment shown in FIG. 3, the temperature sensor 120 here additionally comprises a contact body 124 which circumferentially encloses the measuring tip 121. The protrusion 131, which is required for fastening by clamping between the insulation bodies 142, 143, is formed here together with the contact body 124 on its circumferential surface. The contact body 124 also comprises a contact surface 125, which points in the same direction as the front side 111 of the mounting device 110 and is flush with it. The measuring tip 121 is here inserted into a through hole 126 of the contact body 124, so that the end face 123 and contact surface 125 are flush with each other, and in this arrangement is soldered, welded or otherwise firmly connected to the contact body 124. The contact surface 125 is not covered, at least in sections, by either the mounting device 110 or the insulation device 140. Thus, the contact surface 125 can come into direct contact with the medium 300 in the application and thus increases the effective area via which the measuring tip 121 thermally couples to the medium 300. In particular, this can further improve the response time of the temperature sensor 120. Advantageously, the contact body 124 is made of a material that has a high coefficient of thermal conductivity. The second insulation body 143 comprises an outer thread 144, with which it is screwed into an internal thread 114 of the mounting device 110.

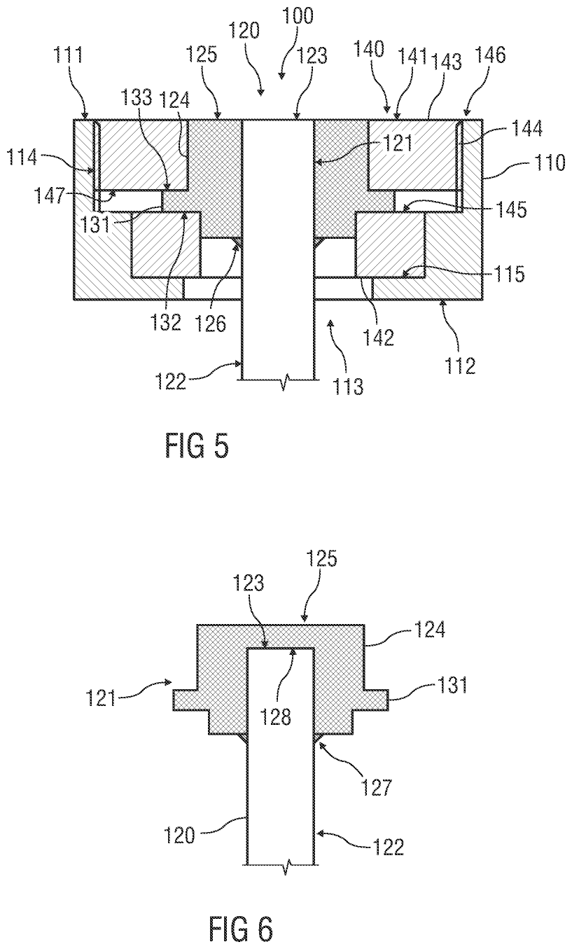

FIG. 6 schematically shows an exemplary embodiment of the temperature sensor 120, which is similar to that shown in FIG. 5. However, the contact body 124 does not comprise a through hole 126 here, but a blind hole 127 on the rear side, into which the measuring tip 121 is inserted in such a way that the end face 123 of the measuring tip 121 comes into contact with an end face 128 of the blind hole 127. Thus, although the measuring tip 121 is protected in use by the contact body 124 from mechanical and chemical impairment by the medium 300, it has a good thermal coupling to the medium 300 via the wide contact surface 125.

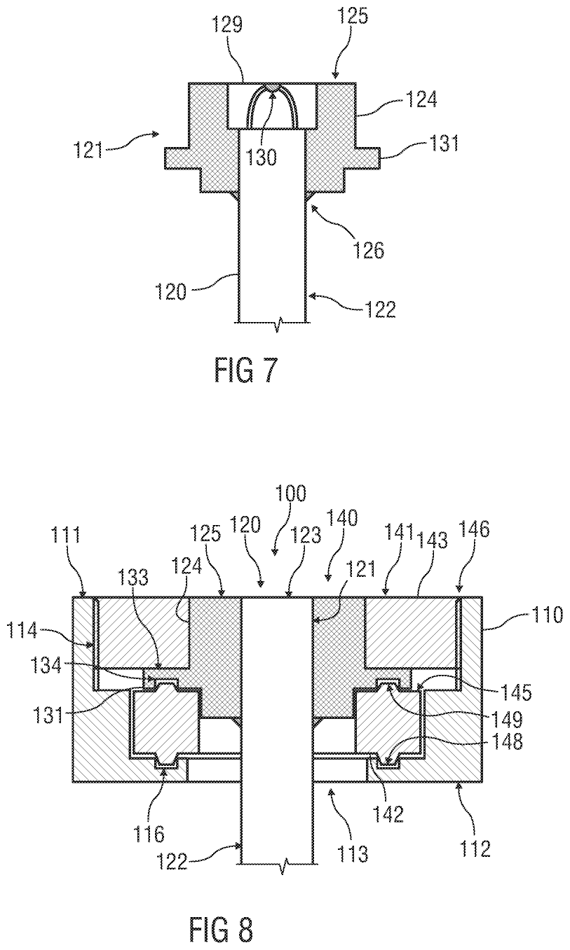

FIG. 7 shows another exemplary embodiment of the temperature sensor 120, which is also similar to that shown in FIG. 5. Here, however, an opening of the through hole 126 on the side of the contact surface 125 is closed by a front membrane 129 and a sensor element 130, which is positioned inside the measuring tip 121 in the other embodiments (not shown in detail in the other figures), is exposed here at the end of the measuring tip 121 and is in direct contact with the front membrane 129. As a result, a particularly high measuring accuracy and particularly low response time can be achieved.

FIG. 8 schematically illustrates another exemplary embodiment of the temperature sensor assembly 100, which is similar to the embodiment in FIG. 5. Here, however, the first insulation body 142 comprises a first sealing contour 148 on its side facing the stop 115 and the stop 115 comprises a first sealing groove 116 corresponding thereto, so that inclined surfaces of the conical sealing contour 148 meet sharp edges of the sealing groove 116. In the region of the first clamping surface 145, the first insulation body 142 comprises a second sealing contour 149, which engages correspondingly in a second sealing groove 134, which is provided on the protrusion 131. By screwing in the second insulation body 143, the edges of the scaling grooves 134, 116 then press into the inclined surfaces of the sealing contours 148, 149, so that an effective seal is achieved and, in particular, in the application, the medium 300 can be prevented from leaking through the temperature sensor assembly 100.

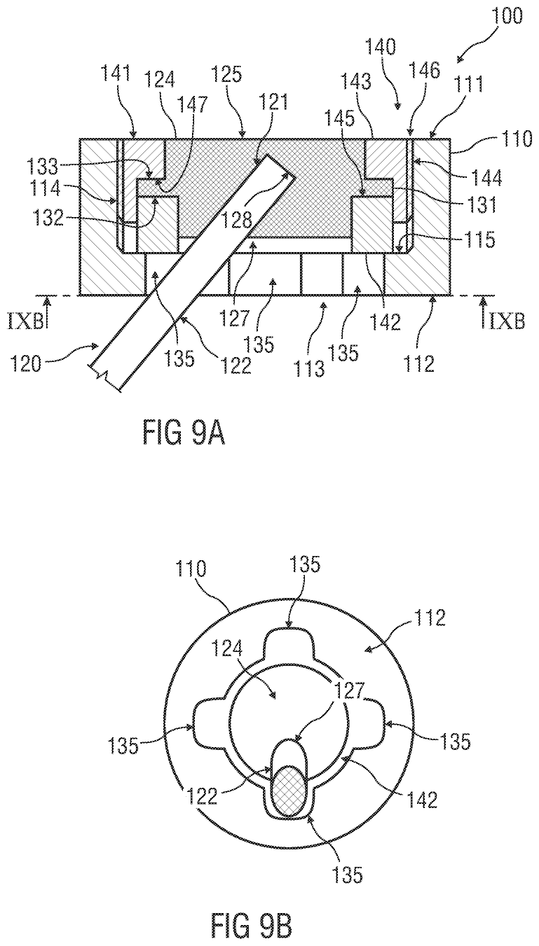

FIGS. 9A and 9B schematically show another exemplary embodiment of the temperature sensor assembly 100, which is also similar to that shown in FIG. 5. In this embodiment, however, the blind hole 127 extends at an angle to a surface normal of the contact surface 125 or the front side 111, as shown in FIG. 9A. As a result, the body 122 of the temperature sensor 120 also emerges from a rear side 112 of the mounting device 110 at an angle.

As shown in FIG. 9B in a rear side view (cross-section IXB, as indicated in FIG. 9A), the mounting device 110 comprises recesses 135 on its rear side 112 which adjoin the opening in the rear side 112 through which the temperature sensor 120 is inserted into the mounting device 110. At least one recess 135 is arranged such that it lies in one plane with the blind hole 127 and a surface normal of the contact surface 125. As a result, the recess 135 creates space for the body 122 of the temperature sensor 120, which protrudes at an angle from the rear side 112, and direct contact between the mounting device 110 and the body 122 is avoided.

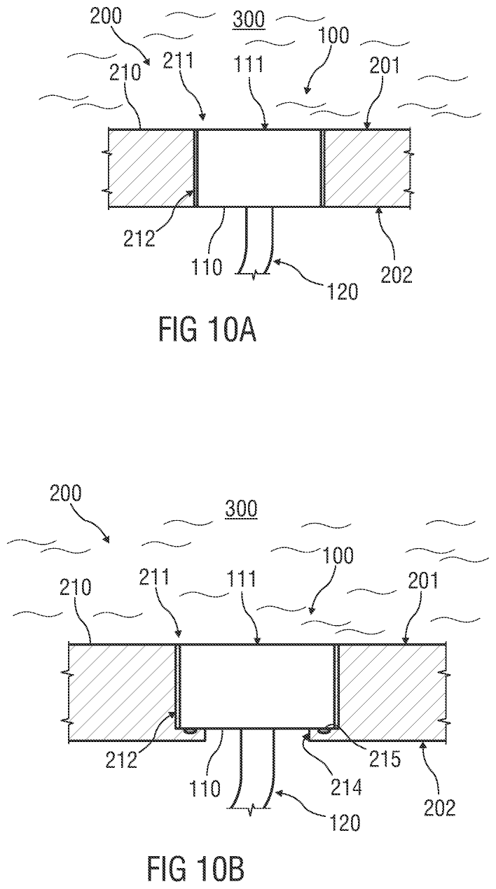

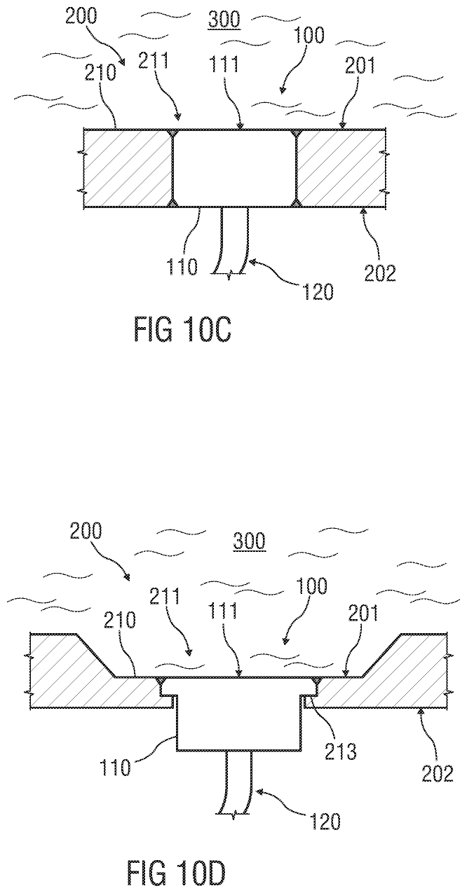

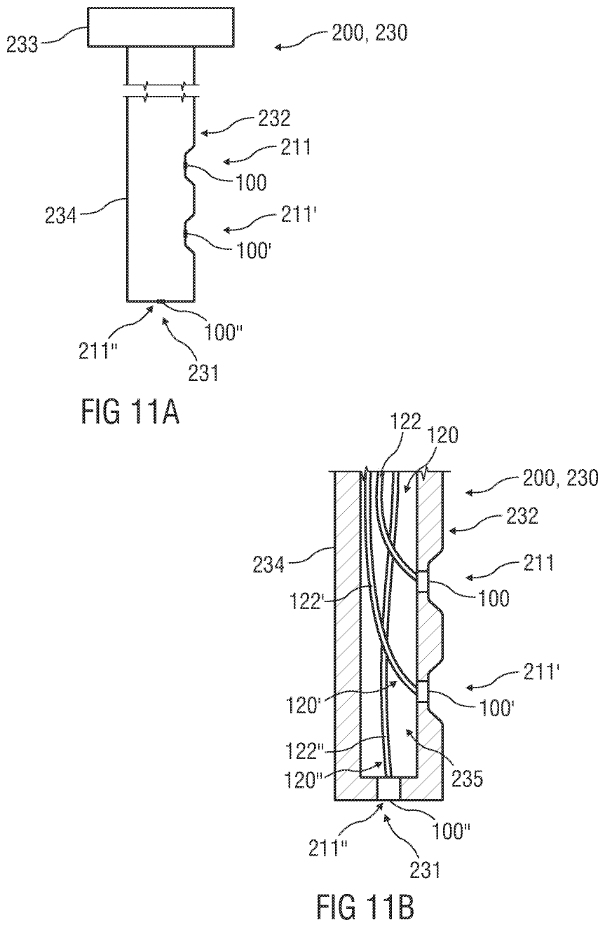

FIGS. 10A, 10B, 10C and 10D show various exemplary embodiments of the sensor carrier 200, wherein in each case a schematically depicted temperature sensor assembly 100—shown herein simplified without its components as a single unit—is provided at the measuring point 211 in the wall section 210 of a device or structure. The outer side 201 of the wall section faces the medium 300 and is in direct contact with it. The inner side 202, on the other hand, faces away from the medium 300. Here, the terms “outside” and “inside” refer to the arrangement relative to the medium 300. Thus, if the structure or device is a protection tube 230, the inside 202 would be equivalent to an inner duct 235 of the protection tube 230 shown in more detail in FIG. 11B. However, if the structure is a container which holds the medium 300 within it, then the inside 202 is equivalent to the outside of the container.

In FIG. 10A, the measuring point 211 comprises a through hole between the inner side 202 and the outer side 201, which is provided with an internal thread. The mounting device 110 of the temperature sensor assembly 100 comprises a matching outer thread and is thus screwed into the wall section 210. A threaded connection 212 created in this way is very easy to implement and may already be sufficient for an application if there are no high requirements for leak-tightness. For additional stability, mounting device 110 and wall section 200 can be fixed to each other by a spot weld. A circumferential weld seam can be provided for increased safety and tightness.

In FIG. 10B, a threaded connection 212 is also provided at the measuring point 211, as well as a stop 214 at the end of the threaded connection 212. The temperature sensor assembly 100 is screwed into the measuring point 212 until it abuts against the stop 214. A sealing ring 215 seals between the outer side 201 and the inner side 202. A welding point can also be provided in this embodiment in order to prevent the mounting device 110 from loosening from the threaded connection 212.

In FIG. 10C, the mounting device 110 is welded into the wall section 210, for example on both sides. This results in a particularly stable and tight connection.

In FIG. 10D, the mounting device 110 is also welded into the wall section 210. The wall section 210 comprises a flattening 213 in the area of the measuring point 211. This can be used to create a defined connection plane for the temperature sensor assembly 100, in particular if the surface of the wall section 210 comprises a curvature, such as the outer surface of a protection tube 230.

Combinations of the four previously illustrated embodiments of the connection between the temperature sensor assembly 100 and the wall section 210 are also conceivable. The schematically simplified temperature sensor assemblies 100 shown in FIGS. 10A-10D can correspond to any of the examples, embodiments or further developments of the same mentioned above.

FIGS. 11A and 11B show a further exemplary embodiment of the sensor carrier 200 in the form of a protection tube 230 with a schematically indicated flange 233 and an elongated protection tube body 234. Temperature sensor assemblies 100, 100′ are arranged along a lateral surface 232 of the protection tube body 234 at a plurality of measuring points 211, 211′. The measuring points 211, 211′ are arranged along a path, which runs parallel to a longitudinal axis of the protection tube 230, with a distance between them. This allows the temperature to be measured at several positions of the protection tube 230, making it possible to record spatial temperature profiles. At a further measuring point 211″ at a distal end 231 of the protection tube body 234, a further temperature sensor assembly 100″ is arranged.

FIG. 11B shows a section of the protection tube body 234 of FIG. 11A in cross-section. A duct 235 runs inside the protection tube body 234, through which temperature sensor bodies 122, 122′, 122″ are led to the temperature sensor assemblies 100, 100′, 100″. However, due to the small diameter of the duct 235, the temperature sensor bodies 122 and 122′ must be curved in order to follow the course of the duct 235. Here, the temperature sensor assemblies 100 and 100′ are realized according to an embodiment as exemplified in FIGS. 9A and 9B, so that the temperature sensor bodies 122, 122′ already enter or depart from the temperature sensor assemblies 100, 100′ at an angle, so that a necessary curvature is significantly flattened.

The present disclosure is not limited to the preceding detailed embodiments. It can be modified within the scope of the following claims. Likewise, individual aspects from the sub-claims can be combined with one another.

1. A temperature sensor assembly, comprising:
a mounting device having a front side and a rear side opposite the front side, and
a temperature sensor with a temperature-sensitive measuring tip, wherein
the temperature sensor is inserted into the mounting device through an opening in the rear side in such a way that the measuring tip points in a direction whose angle to a surface normal of the front side is less than 90°, and
the temperature sensor is held within the mounting device by an insulation device.

2. The temperature sensor assembly according to claim 1, wherein a front face of the insulation device is substantially flush with the front side of the mounting device.

3. The temperature sensor assembly according to claim 1, wherein the mounting device is sleeve-shaped and encloses the insulation device in sections.

4. The temperature sensor assembly according to claim 1, wherein
the mounting device includes a through hole, and
the insulation device includes at least one insulation body with a substantially cylindrical outer surface and is arranged in sections within the through hole.

5. The temperature sensor assembly according to claim 4, wherein
the through hole includes an internal thread in sections, and
the at least one insulation body includes, at least in sections, an outer thread matching the insulation body and is screwed into the mounting device.

6. The temperature sensor assembly according to claim 1 wherein the temperature sensor is formed as a mineral-insulated sheathed cable in the region of the measuring tip.

7. The temperature sensor assembly according to claim 1 wherein the measuring tip includes an end face which is at least substantially flush with the front face and/or at least substantially flush with the front side.

8. The temperature sensor assembly according to claim 1 wherein
the temperature sensor comprises a contact body,
the contact body circumferentially encloses the measuring tip at least in sections, and
the contact body comprises a contact surface which is not covered, at least in sections, by the front side of the mounting device and the front face of the insulation device.

9. The temperature sensor assembly according to claim 8, wherein
the contact body is held by the insulation device, and
the temperature sensor or at least the measuring tip otherwise has no mechanical contact with the insulation device and the mounting device.

10. The temperature sensor assembly according to claim 8, wherein the contact body either:
includes a through hole into which the measuring tip is inserted in such a way that the contact surface is at least substantially flush with an end face of the measuring tip, or
includes a blind hole on a side facing away from the contact surface, into which the measuring tip is inserted in such a way that the measuring tip comes into contact with an end face of the blind hole.

11. The temperature sensor assembly according to claim 10, wherein the through hole or blind hole extends obliquely to a surface normal of the contact surface and/or to the surface normal of the front side, in particular intersects with this or these at an angle of between 15° and 50°.

12. The temperature sensor assembly according to claim 11, wherein
at least one recess is provided in the rear side of the mounting device, which recess adjoins the opening in the rear side through which the temperature sensor is inserted into the mounting device, and
the temperature sensor is guided to the oblique through hole or blind hole without coming into direct contact with the mounting device.

13. The temperature sensor assembly according to claim 8, wherein the contact body is at least partially made of silver, copper, gold, aluminum or of an alloy comprising at least one of these elements.

14. The temperature sensor assembly according to claim 8, wherein
the contact body comprises a through hole, wherein an opening of the through hole is located in the contact surface,
a front membrane closes this opening, and
the measuring tip is inserted into the through hole in such a way that an end face of the measuring tip bears against an inner side of the front membrane.

15. The temperature sensor assembly according to claim 14, wherein a sensor element of the temperature sensor is exposed at the measuring tip and is in direct contact with the inside of the front membrane.

16. The temperature sensor assembly according to claim 1, wherein
the temperature sensor or the measuring tip or the contact body comprises a protrusion which encloses the temperature sensor or the measuring tip or the contact body circumferentially at least in sections,
the insulation device comprises at least a first insulation body and a second insulation body,
the first insulation body is rigidly connected to the mounting device or rests against a stop of the mounting device, so that axial displacement of the first insulation body relative to the mounting device is blocked in one direction,
the first insulation body includes a first clamping surface which points against the blocked direction and faces the protrusion,
the protrusion bears with a first protrusion side against the first clamping surface, and
the second insulation body is screwed to the mounting device or the first insulation body via a threaded connection or is connected to the mounting device or the first insulation body by an adhesive connection or an interference fit, so that a second clamping surface of the second insulation body bears against a second protrusion side of the protrusion, so that the protrusion is clamped between the clamping surfaces of the insulation bodies and an axial displacement of the temperature sensor relative to the mounting device is blocked.

17. The temperature sensor assembly of claim 1 further including a sensor carrier having a wall section with at least one measuring point, wherein
the temperature sensor assembly is arranged at the at least one measuring point, and
the mounting device of the temperature sensor assembly at the measuring point is connected to the wall section or is integrated therein.

18. The temperature sensor assembly of claim 17 further including the at least one additional temperature sensor assembly, wherein
the temperature sensor assemblies are arranged along a path with a distance between each other.

19. The temperature sensor assembly of claim 17 wherein the sensor carrier
is designed as part of a container wall of a container or
as a protection tube, wherein the at least one measuring point is arranged at a distal end or along a lateral surface of the protection tube.

20. A temperature sensor assembly, comprising:
a mounting device having a front side and a rear side opposite the front side;
a temperature sensor with a temperature-sensitive measuring tip;
wherein the temperature sensor is inserted into the mounting device through an opening in the rear side in such a way that the measuring tip points in a direction whose angle to a surface normal of the front side is less than 90°, and
the temperature sensor is held within the mounting device by a sleeve shaped insulator.
